(19) United States
(12) Patent Application Publication
(10) Pub. No.: US 2015/0369434 A1
(43) Pub. Date: Dec. 24, 2015

(54) LIGHT GUIDING ASSEMBLY WITH ADJUSTABLE OPTICAL CHARACTERISTICS

(71) Applicant: KONINKLIJKE PHILIPS N.V., Eindhoven (NL)

(72) Inventors: Johannes Petrus Wilhelmus BAAIJENS, EINDHOVEN (NL); Kars-Michiel Hubert LENSSEN, VELDHOVEN (NL); Arend Jan Wilhelmus Abraham VERMEULEN, DRACHTSTER COMPAGNIE (NL)

(21) Appl. No.: 14/764,320

(22) PCT Filed: Jan. 10, 2014
(86) PCT No.: PCT/IB2014/058164

§ 371 Date: Jul. 29, 2015

Related U.S. Application Data
(60) Provisional application No. 61/758,337, filed on Jan. 30, 2013.

(51) Int. Cl. F21S 11/00; G02F 1/167

(52) U.S. Cl. CPC F21S 11/007; G02F 1/167

(57) ABSTRACT

According to an aspect, a light guiding assembly (1) with a tubular member (2) for guiding light is provided. The light guiding assembly comprises a first layer (51, 61) having a first optical characteristic, the first layer being arranged on an inner wall (5) of the tubular member, and a second layer (52, 62) having a second optical characteristic, the second layer being adjustable at least with respect to the second optical characteristic and with respect to the extent of light allowed to be transmitted through the second layer. The second layer is coupled to a side of the first layer facing away from the inner wall. One of the first and second optical characteristics effects changing of the color of light guided in the tubular member, and the other one of the first and second optical characteristics effects reflection of light guided in the tubular member. Accordingly, the color of daylight guided through the tubular member can be tuned.

### FIELD OF THE INVENTION

The present invention generally relates to the field of light guiding assemblies. In particular, the present invention relates to light guiding assemblies having a tubular member adapted to guide light from an input end of the tubular member to an output end of the tubular member.

### BACKGROUND OF THE INVENTION

Light guiding assemblies, such as skylights, enable use of daylight for indoor illumination. Light is guided from an input end to an output end of a tubular member of the light guiding assembly. Light guiding assemblies are normally arranged e.g. in a ceiling or wall for guiding light there through, such as from an exterior of a building towards an interior of the building. Such light guiding assemblies provide more energy efficient indoor illumination compared to conventional indoor luminaries. An example of a lighting system utilizing daylight is shown in EP2028410. The lighting system comprises a light tube with a highly reflective internal coating. Light enters the light tube and is reflected along the light tube to a delivery point. A drawback with such a lighting system is that the characteristics of the illumination provided by the lighting system (i.e. of the light output from the lighting system) are highly dependent on the characteristics of the light entering the lighting system.

### SUMMARY OF THE INVENTION

It would be advantageous to achieve a light guiding assembly overcoming, or at least alleviating, the above mentioned drawback. In particular, it would be desirable to enable adjustment of color of the light output by a light guiding assembly.

To better address one or more of these concerns, a light guiding assembly having the features defined in the independent claim is provided. Preferable embodiments are defined in the dependent claims.

According to an aspect, a light guiding assembly is provided. The light guiding assembly comprises a tubular member having an inner wall. The tubular member is adapted to guide light from an input end of the tubular member to an output end of the tubular member. The light guiding assembly further comprises a first layer having a first optical characteristic, the first layer being arranged on the inner wall of the tubular member, and a second layer having a second optical characteristic, the second layer being adjustable at least with respect to the second optical characteristic and with respect to the extent of light allowed to be transmitted through the second layer. The second layer is coupled to a side of the first layer facing away from the inner wall. One of the first and second optical characteristics effects changing of the color of light guided in the tubular member, and the other one of the first and second optical characteristics effects reflection of light guided in the tubular member.

By adjusting (or controlling) the second layer with respect to the second optical characteristic and with respect to the extent of light allowed to be transmitted through the second layer (which may be referred to as the extent of light transmission), the color of the light output by the light guiding assembly can be adjusted. Light guided through the tubular member is reflected along the inner wall as it travels or propagates from the input end to the output end of the tubular member. Hence, light guided in the tubular member impinges at, and is redirected by, the inner wall. By adjusting the second layer, the color of the light redirected by the inner wall can be controlled. Daylight normally has a relatively high color temperature, such as up to 5000 K. With the present light guiding assembly, the color of daylight guided through the tubular member can be tuned, such as to a color with lower color temperature.

For example, the first layer may be colored and the second layer may be adjustable at least with respect to reflection. Hence, the first optical characteristic may effect changing of the color of light guided in the tubular member and the second optical characteristic may effect reflection of light guided in the tubular member. The amount of light (impinging at the inner wall) being transmitted through the second layer to the first layer may be controlled by adjusting the second layer with respect to reflection and extent of light transmission. Thus, if the second layer is adjusted towards higher degree of light transmission (i.e. towards a larger extent of light allowed to be transmitted through the second layer) and a lower degree of reflection, a larger amount of light is allowed to reach, and get colored by, the first layer. Further, if the second layer is adjusted towards lower degree of light transmission (i.e. towards a smaller extent of light allowed to be transmitted through the second layer) and a higher degree of reflection, a smaller amount of light is allowed to reach, and get colored by, the first layer. Thus, if a more colored light output of the light guiding assembly is desired, the second layer may be adjusted to a higher degree of light transmission (and lower degree of reflection).

According to another example, the first layer may be reflective and the second layer may be adjustable at least with respect to color. Hence, the first optical characteristic may effect reflection of light guided in the tubular member and the second optical characteristic may effect changing of the color of light guided in the tubular member. Light impinging at the inner wall is first transmitted by the second layer, which adjustably may effect change of color of the transmitted light, and then reflected by the first layer. Thus, the color of the light output by the light guiding assembly is controllable by adjusting the second layer with respect to color.

According to an embodiment, the first optical characteristic of the first layer may be static. Thus, the first layer may not be adjustable with respect to the first optical characteristic, whereby the light guiding assembly may be less technically complex. The control of the color of the light output by the light guiding assembly can be achieved by merely adjusting the second layer.

According to an embodiment, the second layer may comprise electrically controllable particles, wherein the second optical characteristic of the second layer and the extent to which light is allowed to be transmitted through the second layer are adjustable by electrically controlling the particles. The particles may e.g. be controlled by means of electrodes. The particles may be colored for effecting changing of color of light transmitted through the second layer and/or reflective (e.g. opaque, such as white) for effecting reflection and the amount of light transmitted through the second layer. The second layer may comprise an electronic skin (e-skin), wherein the electrically controllable particles are arranged in compartments. The particles may be electrically charged and controllable by selectively applying an electrical field substantially parallel to the e-skin surface (which may be referred to as in-plane electrophoresis). By selectively applying a voltage to electrodes of the e-skin, the particles are caused to be spread in the compartment, whereby the e-skin is colored/reflective, or concentrate at a concentration site of the compartment, such as at the edges of the compartment, whereby the e-skin is non-colored/-reflective, or at least less colored/reflective, such as transparent or translucent). Such e-skin technology is described in more detail in the publications “Bright e-skin technology and applications: simplified grayscale e-paper”, Lenssen et al., Journal of SID 19/4 (2011) pp. 1-7, “Novel concept for full-color electronic paper”, Lenssen et al., Journal of SID 17/4 (2009) pp. 383-388, WO2009153709, WO2009153713 and WO2009153701, which are hereby incorporated by reference in their entirety.

According to an embodiment, said other one of the first and second optical characteristics (i.e. the optical characteristic related to reflection) effects diffuse or specular reflection of light. Hence, the reflective layer (which may be either the first or second layer) may be mirror-like (i.e. specular) or white diffuse.

According to an embodiment, said one of the first and second optical characteristics may effect changing of the color of light guided in the tubular member with respect to color temperature. Low color temperatures (such as below 3000 K) are perceived as warm and high color temperatures (such as over 3000 K) are perceived as cold. In an embodiment, said one of the first and second optical characteristics may effect changing of the color temperature of light guided in the tubular member into a color temperature comprised within an interval of 2000 to 4000 K, preferably 2700 to 3800 K, and most preferably 3000 to 3500 K. Daylight normally has a relatively high color temperature, such as up to 5000 K. The present embodiments allow controllable tuning of daylight guided in the tubular member into a lower color temperature, which often is perceived by a viewer as more comfortable for indoor illumination. The illumination provided by the light guiding assembly may then better resemble a conventional incandescent indoor luminaire.

According to an embodiment, the light guiding assembly may further comprise a controller configured to control the second layer with respect to the second optical characteristic and with respect to the extent of light allowed to be transmitted through the second layer based on input data being one or more of: data input by a user, data received from a light sensor, and predetermined data received from a memory. For example, a light setting (which optionally may be predetermined) may be selected, whereby the controller may adjust the second layer accordingly. The second layer may alternatively, or in addition, be controlled based on the lighting conditions sensed by the sensor at the input side or the output side of the tubular member (such as outdoors or indoors).

According to an embodiment, the tubular member may be adapted to guide daylight from an exterior of a building towards an interior of the building, whereby daylight may be utilized for indoor illumination, which may be a more energy efficient compared to conventional indoor luminaires.

According to an embodiment, the light guiding assembly may further comprise a window arranged so as to transmit light which has been guided in the tubular member. The window may be arranged at the output end of the tubular member or inside the tubular member. The window may reduce the risk of dust (or other undesired foreign matter) to enter the light guiding assembly, thereby facilitating keeping the light guiding assembly clean. Optionally, the window may be adapted to, preferably adjustably, effect change of color of light transmitted through the window and/or the extent of light transmitted through the window. In alternative or in addition, the window may be adjustable e.g. with respect to reflection of light impinging on the window. For example, the window may be configured so as to reflect all or substantially all of the light which has been emitted by the lighting device and which impinges on the window during e.g. night time. According to another example, the window may be configured so as to change color of e.g. daylight input into the input end of the tubular member of the light guiding assembly and guided in the tubular member, e.g. when a relatively low color temperature is desired or required.

According to an embodiment, the light guiding assembly may further comprise a lens arranged at the input end of the tubular member. The lens may be arranged to direct light into the tubular member, thereby increasing the possible illumination output of the light guiding assembly.

According to an embodiment, the light guiding assembly may further comprise a lighting device arranged to output light into the tubular member in direction towards the output end of the tubular member. During dusk, dawn, night time and cloudy weather, it may be desirable to compensate lack of daylight by artificial light. With the present embodiment, the light emitted by the (artificial) light source is guided in the tubular member, and may therefore be tuned with respect to color, by adjusting the second layer. Hence, no additional color filter is required for controlling the color of the light provided by the light source. Further, as the light source is arranged to output light into the tubular member, the light source may mimic the position of sun, thereby reducing the perceived difference between daylight illumination and artificial illumination provided by the light guiding assembly.

It is noted that the invention relates to all possible combinations of features recited in the claims. Further objectives of, features of, and advantages with, the present invention will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiments.

FIG. 1 is a cross-section view of a light guiding assembly according to an embodiment.

FIG. 2 shows the light guiding assembly shown in FIG. 1 from an output side of the light guiding assembly.

FIGS. 3 and 4 are enlarged views of a portion of an inner wall of a tubular member of a light guiding assembly according to an embodiment.

FIG. 5 is an enlarged view of a portion of an inner wall of a tubular member of a light guiding assembly according to another embodiment.

FIG. 6 shows an enlarged view of an electronic skin according to an embodiment.

FIG. 7 is a cross-section view of a light guiding assembly according to another embodiment.

All the figures are schematic, not necessarily to scale, and generally only show parts which are necessary in order to elucidate the invention, wherein other parts may be omitted or merely suggested.

### DETAILED DESCRIPTION

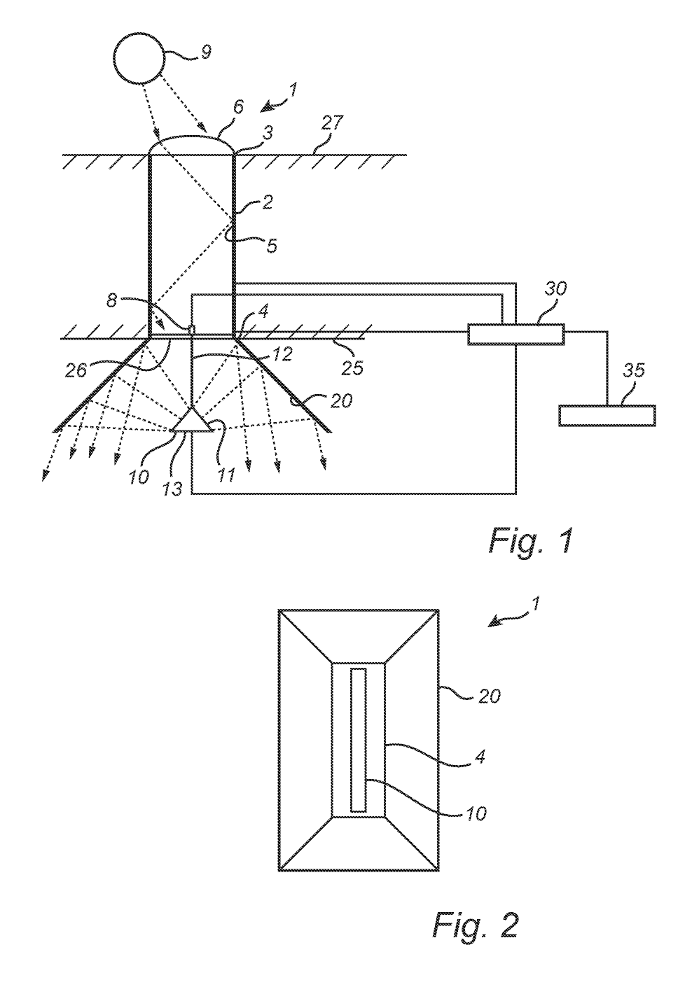

With reference to FIGS. 1 and 2, a light guiding assembly 1 according to an embodiment will be described. FIG. 1 is a cross-section of the light guiding assembly 1 and FIG. 2 shows the light guiding assembly 1 from an output side of the light guiding assembly 1 (i.e. the light guiding assembly 1 seen from a space to be illuminated by the light guiding assembly 1). The light guiding assembly 1 may e.g. be included in or constitute a skylight for guiding daylight into a building, whereby daylight may be used for indoor illumination.

The light guiding assembly 1 comprises a tubular member 2 arranged to guide light from an input end 3 to an output end 4 of the tubular member 2. The tubular member 2 may e.g. be arranged in a wall or roof 25 of a building for guiding light (such as daylight) from an exterior of the building to an interior of the building. The cross-section of the tubular member 2 (taken perpendicular to a longitudinal direction of the tubular member 2) may have any desired shape, such as circular or rectangular (as shown in FIG. 2). The length of the tubular member 2 may be equal or longer than the thickness of the wall or roof 25. The longitudinal extension of the tubular member 25 may be straight, angled or curved.

The light guiding assembly 1 may further comprise a lens 6 for directing (preferably focusing) light into the tubular member 2. The lens 6 may be arranged at the input end 3 of the tubular member 2.

The light guiding assembly 1 may further comprise an artificial lighting device 10. The light output of the lighting device 10 may be used as a complement to the daylight output of the tubular member 2. The lighting device 10 may be connected to the tubular member 2 via a frame 12. The light guiding assembly 1 may further comprise a reflector 20 arranged to reflect light emitted by (and/or reflected at) the lighting device 10 towards the space to be illuminated by the light guiding assembly 1. Alternatively (or as a complement), the lighting device 10 may be arranged to emit (and/or reflect) light towards a portion of the ceiling (or wall) 25 surrounding the output end 4 of the tubular member 2. In the present specification, such portion of the ceiling (or wall) 25 and the reflective surface of the reflector 20 may be referred to as a secondary reflective surface. The reflector 20 comprises a divergent structure, whereby the reflector 20 is flared in direction away from the output end 4 of the tubular member 2 (i.e. towards the space to be illuminated by the light guiding assembly 1). The reflector 20 may be arranged at the rim of the output end 4 of the tubular member 2.

The lighting device 10 comprises one or more light sources 13, such as light emitting diodes (LEDs), arranged to emit light at least in direction towards the secondary reflective surface (e.g. towards the reflector 11). Optionally, the light source 13 may be arranged to further emit light in directions towards the space to be illuminated by the light guiding assembly 1 (i.e. in a main forward illumination direction of the light guiding assembly 1).

The lighting device 10 may further comprise a layer 11 adjustable with respect to reflection and to the extent of light allowed to be transmitted through the layer 11. Hence, the layer 11 is switchable (or tunable) between a (at least partly) reflective mode and a light transmitting mode. The layer 11 may comprise electrodes and reflective particles arranged in compartments and being controllable by the electrodes. For example, the layer 11 may comprise an e-skin. By selectively applying a voltage to the electrodes of the e-skin, the particles are caused to be spread in the compartment (whereby the e-skin is reflective) or hide at the edges of the compartment (whereby the e-skin is light transmitting, or at least less reflective, such as transparent or translucent). Optionally, the layer 11 may further be adjustable with respect to color. Hence, the layer 11 may be arranged to adjustably effect change of color of light being reflected by and/or transmitted through the layer 11. The layer 11 may then comprise colored particles, preferably arranged in an e-skin.

The lighting device 10 may comprise a tapered structure on which the layer 11 may be arranged (or coupled), such that light output from the tubular member 2 and impinging at the layer 11 is redirected towards the secondary reflective surface (e.g. the reflector 20 or ceiling 25). For example, the tapered structure may be a tapered exit surface of the light source or a separate structure (such as a sheet) for supporting the layer 11. The tapered structure is arranged to be tapered in direction towards the output end 4 of the tubular member 2. In the present example, the tapered structure is shaped as a triangular prism. However, the tapered structure may have any desired tapered shape, such as a convex shape, in order to reflect light output from the tubular member 2 towards the secondary reflective surface.

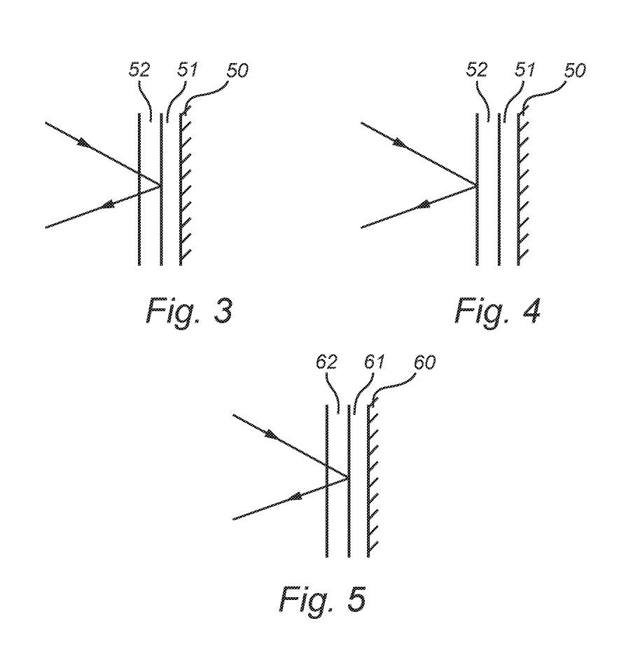

The light guiding assembly 1 may further comprise at least a first layer and a second layer arranged on an inner wall 5 of the tubular member 2. The first and second layers will be described in more detail with reference to FIGS. 3 and 4 in the following.

The first layer 51 may be applied as a coating on the inner wall 50 of the tubular member. In the present example illustrated in FIGS. 3 and 4, the first layer 51 is adapted to effect change of color of light impinging at the first layer 51 (which may be referred to as a first optical characteristic in the present example). For example, the first layer 51 may comprise a colored layer of paint. Preferably, the first layer 51 may have a warm color for effecting change of the color temperature of light impinging at the first layer 51 to a color temperature within the range 2000 to 4000 K, preferably 2700 to 3800 K, and most preferably 3000 to 3500 K. For example, the first layer 51 may be red, orange or yellow for tuning daylight typically having a color temperature of up to 5000 K to a lower color temperature. The second layer 52 is adjustable with respect to reflection (which may be referred to as a second optical characteristic in the present example) and the extent of light allowed to be transmitted through the second layer 52. Hence, the second layer 52 is adjustable (such as tunable) between a (at least partly) reflective mode and a (at least partly) light transmitting mode. When the second layer 52 is in the light transmitting mode (as illustrated in FIG. 3), light is allowed to be transmitted through the second layer 52 and reflected by the first layer 51. As the light is reflected by the colored first layer 51, the color of the light is changed. When the second layer 52 is in the reflective mode (as illustrated in FIG. 4) light is reflected by the second layer 52 before it reaches the first layer 51, whereby the color of the light remains unchanged. Accordingly, the color of the light propagating in the tubular member may be tuned by adjusting the reflective and light transmission characteristics of the second layer 52.

According to another example illustrated in FIG. 5, the first layer 61 is reflective (which may be referred to as a first optical characteristic in the present example). The first layer 61 may be specular reflective or (diffuse) white (such as a layer of white paint). Further, the second layer 62 is adapted to adjustably effect change of color of light transmitted through (or reflected by) the second layer 62. Hence, the second layer 62 is adjustable (such as tunable) between a (at least partly) colored mode and a (at least almost) non-colored mode. When the second layer 62 is in the colored mode, the color of light transmitted through the second layer 62 is changed. When the second layer 62 is in the non-colored mode, the color of light transmitted through the second layer 62 remains un-changed. The light transmitted by the second layer 62 is reflected by the reflective first layer 61, as illustrated in FIG. 5. Accordingly, the color of the light traveling or propagating in the tubular member may be tuned by adjusting the color characteristics of the second layer 62. The color of the second layer 62 in the present example may be equal to the color of the second layer 52 according to the preceding example.

In both of the above examples described with reference to FIGS. 3 to 5, the second layer 52, 62 may comprise electrodes and (reflective, e.g. white, or colored) particles arranged in compartments and being controllable by the electrodes. For example, the second layer 52, 62 may comprise an e-skin. By selectively applying a voltage to the electrodes of the e-skin, the particles are caused to be spread in the compartment (whereby the e-skin is reflective or colored) or hide at the edges of the compartment (whereby the e-skin is non-, or at least less, reflective or colored, such as transparent or translucent).

Referring again to FIG. 1, the light guiding assembly 1 may further comprise a window 26 arranged to substantially cover the output end 4 of the tubular member 2 so as to transmit light which has been guided in the tubular member 2. The window 26 may be a plain non-colored glass (or plastic) window for covering and protecting the interior of the tubular member 2. Alternatively, the window 26 may be adapted to, preferably adjustably, effect changing of color of light transmitted through the window 26 and/or the extent of light allowed to be transmitted through the window 26.

The window 26 may be adapted to controllably effect changing of color temperature of light transmitted through the window 110, preferably to a color temperature below 4000 K, preferably below 3400 K, and most preferably below 2700 K. The window 26 may be adjustable with respect to colors enabling tuning the color of the window 26 from yellow via orange to red for achieving relatively warm colors of the light transmitted through the window 26. These colors and color temperatures may be provided by mixing yellow and magenta. For achieving cooler color temperatures, cyan may be added to the mixing. Black may be used for blocking light. For the purpose of effecting change of color of light transmitted through the window 26, the window 26 may comprise electronically controllable colored particles. For example an electronic skin (e-skin) may be coupled to a surface of the window.

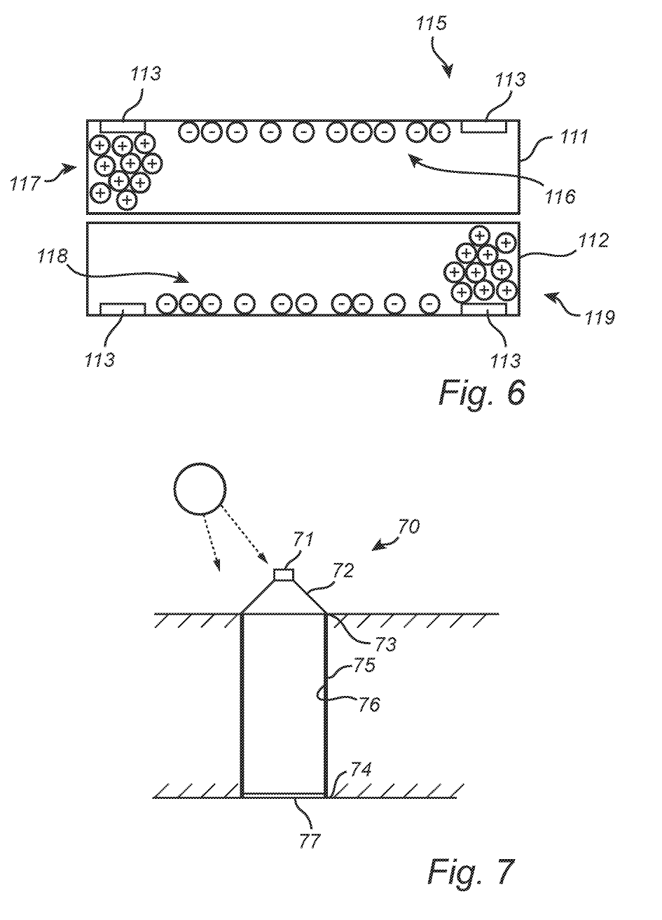

An example of an e-skin, which may be comprised in the layer of the lighting device, arranged at the inner wall of the tubular member and/or in the window will be described with reference to FIG. 6 showing an enlarged view of an electronic skin 115. The e-skin 115 may comprise one or more layers, each layer having a plurality of compartments (or cells) 111, 112, as illustrated in FIG. 2. In the present example, the e-skin 115 comprises a first layer and a second layer overlapping each other. A first compartment 111 of the first layers is arranged on (such as coupled to) a second compartment 112 of the second layer. The first compartment 111 encloses positively charged cyan particles 117 and negatively charged yellow particles 116, and the second compartment 112 encloses negatively charged magenta particles 118 and positively charged black particles 119. By adjusting an in-plane electrical field applied between the electrodes 113 of the first compartment 111, the yellow particles 116 can be caused to spread in the first compartment 111 and the cyan particles can be caused to concentrate at a relatively small region, such as at the edge of the first compartment 111, whereby the first compartment portion of the first layer turns yellow. Similarly, by adjusting an in-plane electrical field applied between the electrodes 113 of the second compartment 112, the magenta particles 118 can be caused to spread in the second compartment 112 and the black particles 119 can be caused to concentrate at a relatively small region, such as at the edge of the second compartment 112, whereby the second compartment portion of the second layer turns magenta. As the two layers overlap, a mix of yellow and magenta occurs in the e-skin 115. According to the same principle, the cyan and black particles 117, 119 can be caused to spread and the yellow and magenta particles 116, 118 to concentrate at the edges in the compartments 111, 112. Hence, the particles of a certain color are independently controllable with respect to the particles of other colors.

Turning again to FIG. 1, operation of the light guiding assembly 1 will be described. During daytime, daylight (from the sun 9, as schematically illustrated in FIG. 1) is directed by the lens 6 into the input end 3 of the tubular member 2. The daylight is reflected at the inner wall 5 (and the first and/or second layer applied thereon) towards the output end 4 of the tubular member 2. Dependent on the setting (or configuration) of the second layer, the light guided in the tubular member may change color. The daylight exits the tubular member 2 through the window 26, which dependent on its setting (or configuration) may change the color of and/or block (at least a portion of) the light. Some of the light exiting the tubular member 2 may impinge on the lighting device 10. Dependent on the setting (or configuration) of the layer 11 of the lighting device 10, (at least a portion of) the light impinging on the layer 11 is redirected towards the reflector 20, which in turn reflects the light towards the space illuminated by the light guiding assembly 1.

The light guiding assembly 1 may further comprise a control unit (or controller) 30 for controlling one or more of: the second layer at the inner wall 5 of the tubular member 2, the window 26, the layer 11 of the lighting device 10 and the light source 13 of the lighting device 10. The light guiding assembly 1 may further comprise a user interface 35 communicatively coupled to the control unit 30. The light guiding assembly 1 may further comprise at least one sensor 8 configured to sense, and transmit a signal indicative of, the color (and/or color temperature) and/or brightness (and/or any other light characteristic) of light. Optionally, two (or more) separate sensors 8 may be provided, such as one for sensing color and one for sensing brightness. Alternatively, one sensor 8 may be provided for sensing both color and brightness. The sensor 8 may be located at the window 26 (as illustrated in FIG. 1), or at any position at the inside or outside of the wall or roof 27 or in the tubular member 2 for sensing light, which is to be and/or has been output by the light guiding assembly 1.

The control unit 30 may be configured to control the light guiding assembly 1 based on one or more of: the signal from the sensor 8 indicative of color and/or brightness, data input via the user interface 35 and predetermined data (e.g. stored in a memory). For example, a user may select a predetermined light setting for the light guiding assembly 1 (e.g. specified in illumination brightness and/or color). The control unit 30 may then control the light guiding assembly 1 to provide the selected light setting based on the sensed lighting conditions.

For example, a light setting with a brightness of 500 lux and a color temperature of 3000 K may be selected when the sensor 8 senses a brightness of 3000 lux and a color temperature of 4000 K. The control unit 30 may then control the light guiding assembly 1 (based on a signal from the sensor 8), for example by adjusting: the second layer at the inner surface 5 for effecting change of color of light guided in the tubular member 2, and/or the color of the window 26 for effecting change of color of light transmitted through the window 26, such that light output from the light guiding assembly 1 has a color temperature of about 3000 K. Further, the control unit 30 may control the degree of light transmission of the window 26, such that the brightness of light which has been transmitted through the window 26 is about 500 lux. Hence, the window 26 is controlled to block some of the light input. Further, as the light output from the tubular member 2 has a proper brightness (i.e. 500 lux after passing the window 26), the control unit 26 may control the light source 13 to be switched off and the layer 11 of the lighting device 10 to be in a reflective mode, such that light exiting the tubular member 2 and impinging on layer 11 is reflected towards the reflector 20, which in turn reflects the light towards the space illuminated by the light guiding assembly 1.

According to another example, a light setting with a brightness of 500 lux and a color temperature of 3000 K (i.e. the same light setting as in the previous example) may be selected when the sensor 8 senses zero brightness (and consequently no color temperature). The control unit 30 may then control the light guiding assembly 1 (based on a signal from the sensor 8), for example by switching on and adjusting the brightness of the lighting device 10 to 500 lux and the layer 11 of the lighting device 10 to be in a light transmitting mode (i.e. a non-reflective mode), such that light emitted by the light source 13 impinges at the reflector 20, which in turn reflects the light towards the space illuminated by the light guiding assembly 1.

A light guiding assembly according to another embodiment will be described with reference to FIG. 7.

FIG. 7 shows a light guiding assembly 70, which may be equally configured as the lighting guiding assembly described with reference to FIGS. 1 to 6, except that the light guiding assembly 70 may comprise a (artificial) lighting device 71 arranged to emit light into the tubular member 75 towards the output end 74 of the tubular member 75. The lighting device 71 may be mounted to the input end 73 of the tubular member 75 by a frame 72. In the present embodiment, the characteristics (such as the color and/or brightness) of the light from the lighting device 71 may be adjusted by controlling the second layer of the inner wall 76 of the tubular member 75 and/or the window 77.

While embodiments have been illustrated and described in detail in the drawings and foregoing description, such illustration and description are to be considered illustrative or exemplary and not restrictive; the invention is not limited to the disclosed embodiments.

For example, even though a light guiding assembly for guiding daylight into a building is described as an exemplifying embodiment in the present specification, it will be appreciated that the light guiding assembly may as well be used for other applications where it is desirable to guide light from an input end to an output end of a tubular member. Further, it will be appreciated that more than two layers with different optical characteristics may be applied to the inner surface of the tubular member.

Further, even though a window, an adjustable layer of the lighting device and a second layer at the inner wall of the tubular member comprising e-skins are described as exemplifying embodiments in the present specification, it will be appreciated that the change of color and/or reflection and/or amount of light transmitted may as well be achieved by other techniques, such as electrophoresis, electrokinetic, electrowetting, suspended particles devices, liquid crystal or electro chromic techniques.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A light guiding assembly arranged for adjusting the color of the light output by said light guiding assembly, the light guiding assembly comprising:
a tubular member having an inner wall, the tubular member being adapted to guide light from an input end of the tubular member to an output end of the tubular member,
a first layer having a first optical characteristic, the first layer being arranged on the inner wall of the tubular member, and
a second layer having a second optical characteristic, the second layer being adjustable at least with respect to the second optical characteristic and with respect to the extent of light allowed to be transmitted through the second layer, the second layer being coupled to a side of the first layer facing away from the inner wall,
wherein
the first layer is colored and the second layer is adjustable at least with respect to reflection.

2. (canceled)

3. (canceled)

4. The light guiding assembly as defined in claim 1, wherein the first optical characteristic of the first layer is static.

5. The light guiding assembly as defined in claim 4, wherein the second layer comprises electrically controllable particles, wherein the second optical characteristic of the second layer and the extent to which light is allowed to be transmitted through the second layer are adjustable by electrically controlling the particles.

6. The light guiding assembly as defined in claim 5, wherein said other one of the first and second optical characteristics effects diffuse or specular reflection of light.

7. The light guiding assembly as defined in claim 6, wherein said one of the first and second optical characteristics effects changing of the color of light guided in the tubular member with respect to color temperature.

8. The light guiding assembly as defined in claim 7, wherein said one of the first and second optical characteristics effects changing of the color temperature of light guided in the tubular member into a color temperature comprised within an interval of 2000 to 4000 K.

9. The light guiding assembly as defined in claim 1, further comprising a controller configured to control the second layer with respect to the second optical characteristic and with respect to the extent of light allowed to be transmitted through the second layer based on input data being one or more of: data input by a user, data received from a light sensor, and predetermined data received from a memory.

10. The light guiding assembly as defined in claim 1, wherein the tubular member is adapted to guide daylight from an exterior of a building towards an interior of the building.

11. The light guiding assembly as defined in claim 1, further comprising a window arranged so as to transmit light which has been guided in the tubular member.

12. The light guiding assembly as defined in claim 11, wherein the window is adjustable with respect to reflection of light impinging on the window, the color of light transmitted through the window, and/or the extent of light allowed to be transmitted through the window.

13. The light guiding assembly as defined in claim 1, further comprising a lens arranged at the input end of the tubular member, the lens being arranged to direct light into the tubular member.

14. The light guiding assembly as defined in claim 1, further comprising a lighting device arranged to output light into the tubular member in direction towards the output end of the tubular member.

15. A light guiding assembly arranged for adjusting the color of the light output by said light guiding assembly, the light guiding assembly comprising:
a tubular member having an inner wall, the tubular member being adapted to guide light from an input end of the tubular member to an output end of the tubular member,
a first layer having a first optical characteristic, the first layer being arranged on the inner wall of the tubular member, and
a second layer having a second optical characteristic, the second layer being adjustable at least with respect to the second optical characteristic and with respect to the extent of light allowed to be transmitted through the second layer, the second layer being coupled to a side of the first layer facing away from the inner wall,
wherein the first layer is colored and the second layer is adjustable at least with respect to reflection, wherein the first layer is reflective and the second layer is adjustable at least with respect to color.
